(19) United States
(12) Patent Application Publication
(10) Pub. No.: US 2004/0020921 A1
(43) Pub. Date: Feb. 5, 2004

(54) Bacon cooker

(76) Inventor: Valentine Hechler IV, Northfield, IL (US)

Correspondence Address: NIXON PEABODY, LLP, 401 9TH STREET, NW, SUITE 900, WASINGTON, DC, 20004-2128, US

(21) Appl. No.: 10/405,361

(22) Filed: Apr. 3, 2003

Related U.S. Application Data
(60) Provisional application No. 60/369,338, filed on Apr. 3, 2002.
(60) Provisional application No. 60/390,123, filed on Jun. 21, 2002.

(51) Int. Cl. H05B 6/64

(52) U.S. Cl. 219/679; 219/680

(57) ABSTRACT

A bacon cooker and method for microwave cooking of bacon. The bacon cooker includes an outer container, an inner container, a rack, and a lid. The lid is releasably attached to the container via a plurality of cam locks that which engage the container and rim and force the rim into the engagement with the underside of the lid. Lever arms with clasps specifically dimensioned to securely engage the outside wall of the lid when the cam locks in are the locked position. The rack is dimensioned to fit inside the container and consists of a plurality of radially extending vanes over which bacon is hung for cooking. The rack includes a upwardly extending stem with alternate vanes dimensioned to fit within a centrally located bore on the lid for securing the container to the lid. A microwave reflective surface is positioned between vacuum sealed outer and inner containers.

### BACKGROUND OF THE INVENTION

1. Field of the Invention

The present invention relates to a method and apparatus for cooking bacon or the like in a microwave oven.

2. Description of the Related Art

Uncooked strips of bacon can be prepared for eating by frying bacon in a skillet or by cooking the bacon in a microwave oven. Microwave cooking is often preferred due to the shorter time necessary to cook the bacon. Various microwave bacon cooker devices are known for holding the bacon during cooking, including those shown by U.S. Pat. Nos. D318,206; D366,807; 4,075,102; 4,112,883; 4,214,515; 4,343,978; 4,924,049; 4,933,528 and 6,211,502.

A plethora of concerns and problems arise when cooking bacon in a microwave oven. The grease produced during cooking is both messy and hot, and must be retained for disposal. Bacon that is allowed to cook on a horizontal surface will often become soaked with grease, rendering the food unpalatable. In the case of a cooking device that holds the bacon, it is desirable that the device be easy to manufacture and ease to use, while at the same time allowing for aesthetically pleasing, properly cooked, and good tasting bacon. Also, the issue of cleanup is a major concern. Ideally, because of the possibility of splattering grease generated during the cooking of the bacon, it would be beneficial to cook the bacon in a closed container.

While U.S. Pat. No. 6,211,502 to Hechler provides a bacon cooker that adequately solves many of the problems associated with the prior art, it is still subject to several disadvantageous limitations relating to the products performance, safety, and ease of use.

### SUMMARY OF THE INVENTION

A primary object of the present invention is to provide a novel and improved apparatus for cooking bacon or other similar food strips in a microwave oven while minimizing the problems associated with prior apparatus.

A further object of the present invention is to provide a novel and improved apparatus for cooking bacon or the like in a microwave oven while preventing the mess associated with the prior art apparatus.

Yet a further object of the present invention is to provide a novel and improved apparatus for cooking bacon or the like in a microwave oven while preventing the destructive explosions of superheated steam that are common with prior art apparatus.

Another object of the present invention is to provide a novel and improved apparatus for cooking bacon or the like in a microwave oven while decreasing the risk of injury associated with the prior art apparatus.

It is a further object of the present invention to provide a novel and improved bacon cooker having a cover unit for closing the open end of a microwave permeable container. The container is provided with an annular rim at the open end, and the cover includes improved cam locks that engage and force the rim against the cover.

Yet another object of the present invention is to provide a novel and improved bacon cooker having a cover for engaging and closing the open end of a container. The cover is provided with a steam vent formed by an elongate, open ended shaft which defines a vent passage of constricted cross section to prevent liquid fat from exiting through the steam vent.

Another object of the present invention is to provide a novel and improved bacon cooker having a cover for engaging and closing the open end of a container.

A still further object of the present invention is to provide a novel and improved bacon cooker having a cover unit, a microwave penneable container, and a rack for holding bacon. The rack includes radially spaced outward extending vanes over which bacon is hung for cooking and is dimensioned to fit inside the microwave permeable container. The rack further includes an upwardly extending shaft with radially extending projections fitted to engage and secure the cover unit.

Yet a further object of the invention is to provide a novel and improved bacon cooker having a cover unit including an improved handle for safe and easy handling and compact storage of the cover unit.

A further object of the present invention is to provide a novel and improved bacon cooker including an inner and outer container with a thin microwave reflecting surface, e.g. aluminum foil, foil positioned therebetween.

Yet a further object of the present invention is to provide a novel and improved bacon cooker that is capable of preparing uniformly cooked and palatable bacon.

These and other objects of the present invention are achieved by providing a microwave permeable lid, a microwave permeable container, and a microwave permeable rack dimensioned to fit inside the container. The container has an open end with an annularly extending, laterally projecting rim. The cover unit releasably attaches to the container by cam locks and includes a centrally-located bore with laterally extending protrusions from the inside portion of the cover unit defining the bore. A plurality of radially vanes are affixed to the rack. The vanes contain an upwardly extending portion dimensioned to fit within the centrally located bore in the lid. In a preferred embodiment, the apparatus includes an inner and an outer container with a layer of aluminum foil positioned therebetween.

### BRIEF DESCRIPTION OF THE DRAWINGS

FIG. 1 is a side view of the assembled bacon cooker 10 of the present invention;

FIG. 2 the side view of the container 100;

FIGS. 3A and 3B is a plan view and a side view, respectively, of the rack 200;

FIGS. 4A-4E is a side of the lid 200, a plan view of the lid 300, and a side view of the lid handle 322, a side view of the alignment tabs 323, and a partial cross-section of the clasp 342 engaging the peripheral rim 314, respectively; and

FIG. 5 is a side view of the bacon cooker 20 of the present invention.

### DETAILED DESCRIPTION OF THE PREFERRED EMBODIMENTS

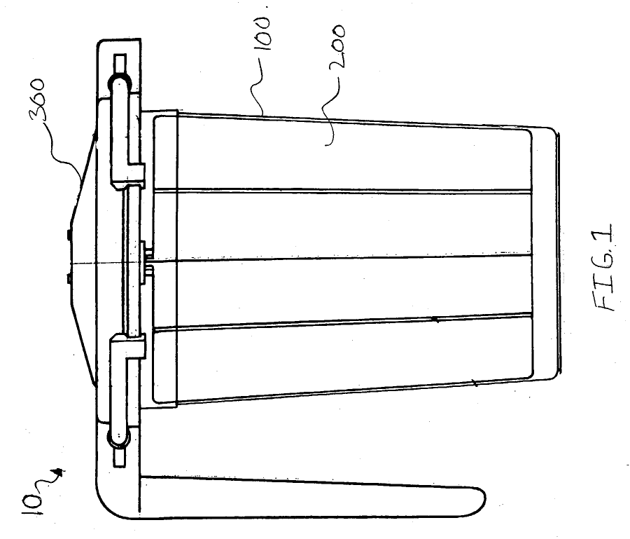

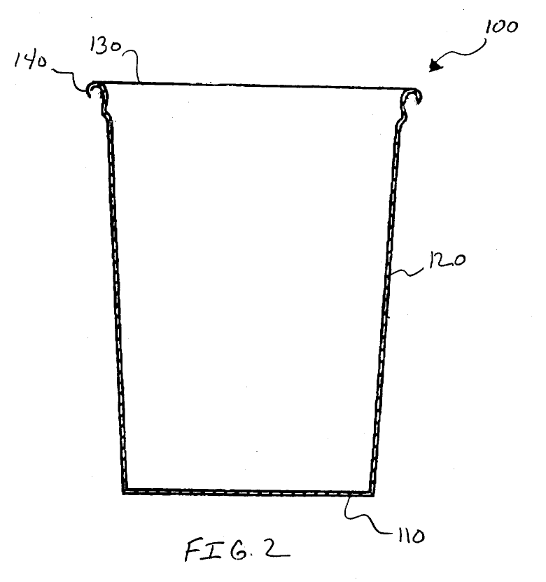

Referring now to FIG. 1, the bacon cooker of the present invention indicated generally at 10 consists of a container 100 (illustrated as being transparent), a rack 200, and a lid 300 formed to cooperate with a rimmed, disposable microwavable permeable container. As shown in FIG. 2, container 100 has a bottom wall 110 and a sidewall 120 terminating at an open end 130 defined by an annular, laterally projecting rim 140 of the type found on many conventional containers. Ideally, container 100, rack 200 and lid 300 are made of low cost plastic which retains stiffness and strength at elevated temperatures involved in microwaving bacon is capable of retaining hot grease.

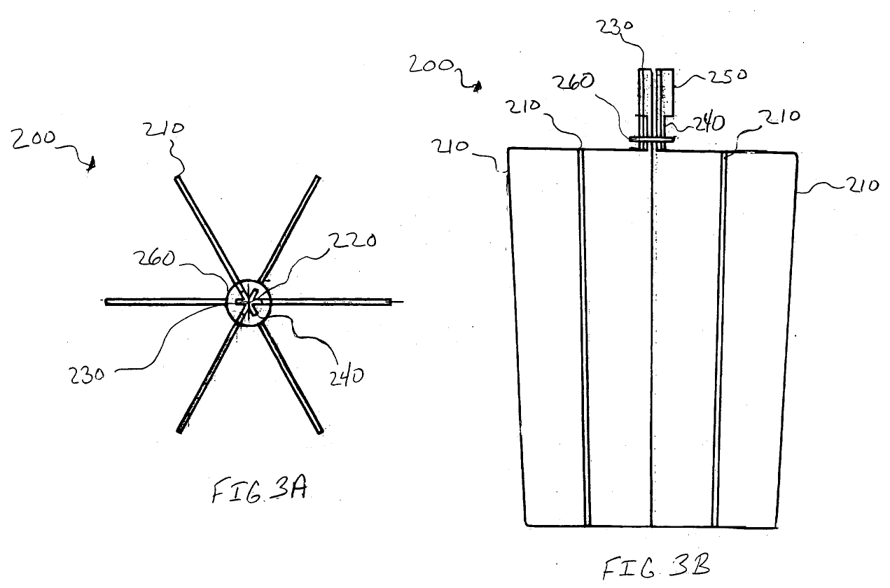

As shown in FIGS. 3A-3B, rack 200 consists of a plurality, preferably six, radially extending vanes 210 over which bacon is hung for cooking. Vanes 210 are joined at a common center 220 and are dimensioned to fit within container 100. A bayonet-like stem 230, formed from upwardly extending vane projections 240, extends upwardly from center 220 of the rack 200. Three of the vane projections 240 have laterally extending tabs 250, such that the upper portion of the other three vane projections 240 is wider than the lower portion thereof. A support disc 260 is positioned under tabs 250 on the lower portion of stem 230 to maintain proper spacing between rack 200 and lid 300 when the bacon cooker 10 is assembled.

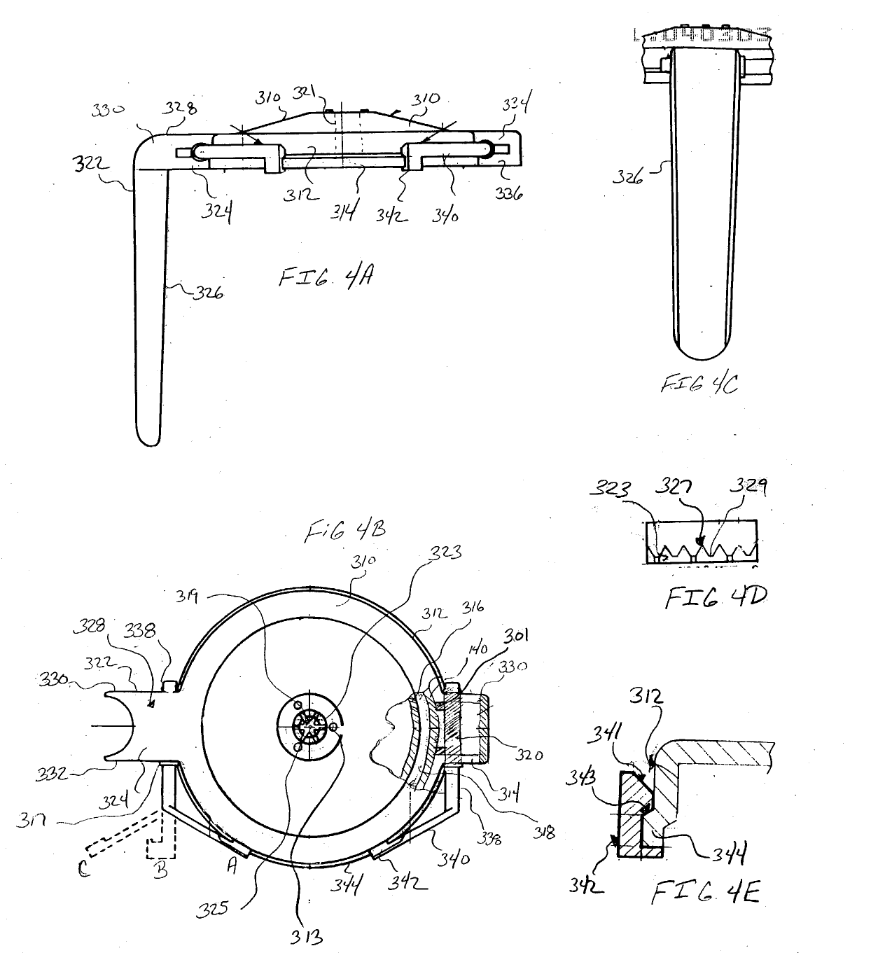

Referring now to FIGS. 4A-4E, lid 300 has a top wall 310 connected to an outer sidewall 312 having a peripheral rim 314. Extending downward from the underside of top wall 310 is an inner side wall 316 (shown by dashed lines), so as to form a container rim receiving compartment 318 extending annularly around top wall 310. Rim 140 of a container 100 is inserted into the rim receiving compartment 318 until it engages the underside of top wall 310. The rim receiving compartment 318 can be made large enough to receive containers having open ends of different diameters. Top wall 310 is provided with a central bore 319 of sufficient diameter to receive and engage stem 230. A bore wall 321 (shown by dashed lines in FIG. 4A) extends downwardly from the underside of top wall 310 to define central bore 319. Extending laterally from the bottommost portion of bore wall 321 into central bore 319 are a alignment tabs 323 spaced so as to define three slots 325 dimensioned to receive laterally extending tabs 250 on stem 230 of rack 200. The top surface of alignment tabs 323 include two teeth 327, the inside edges of which are sloped downwards so as to form groove 329, as shown in FIG. 4D. Rack 200 can be secured to lid 300 in a bayonet-like fashion prior to inserting rack 200 into container 100 by fully inserting tabs 250 into slots 325 and rotating the lid such that the bottom of tabs 250 are aligned with grooves 329 in alignment tabs 323. The downwardly sloping edges of teeth 327 are operative to direct tabs 250 into slots 325 in the event that tabs 250 are not perfectly aligned with grooves 329. Slots 325 are of sufficient size to vent steam from the bacon cooker 10 during microwave cooking while preventing significant passage of grease from the container. The top wall 310 of lid 300 preferably includes a plurality of raised dots 313 vertically aligned with grooves 329, to facilitate the tactile location of grooves 329 and assist in the proper positioning of lid 200 onto container 100.

It is important for the container 100 to be firmly attached to the lid 300 during the microwave cooking process, for if the cover unit should be detached, the microwave oven will be splattered with grease exiting the open end 130 of the container. To removably secure a container in place, lid 300 is provided with two or more cam locks 320 which engage the underside of container rim 140 when the cam locks lock in place, as shown in FIGS. 4A-4C. One cam lock is mounted in handle 322. Handle 322 preferably consists of a neck 324 and a grasping arm 326. Neck 324 consists of a neck top wall 328 that is coextensive with lid top wall 310 and which joins downwardly extending neck sidewalls 330 and 332. Grasping arm 336 joins the distal end of neck top wall 328 relative to lid top wall 310 and extends downwardly from neck 324. Thus, when lid 300 is attached to container 100, container sidewall 120 and grasping arm 326 are substantially parallel to one another. Neck 324 preferably extends a distance laterally from lid top wall 310 such that one's hands do not touch any portion of container 100 when handling grasping arm 326 of handle 322. The downward configuration of grasping arm 326 allows for easy handling and storage of the bacon cooker 10.

A second cam lock is mounted in a lock mount 330 which extends laterally from lid outer sidewall 312. This lock mount is positioned opposite to the handle 322 and includes a top wall 314 which is coextensive with lid top wall 310 and which joins downwardly extending, spaced lock mount sidewalls 334 and 336.

The construction of the cam locks 320 are identical. Each cam locks includes a pivot pin 338 mounted for pivotal movement. The pivot pin for one cam lock extends between the handle sidewalls 330 and 332 and is mounted for rotation therein, while the pivot pin for the opposed cam lock extends between the lock mount sidewalls 334 and 336 and is mounted for rotation therein. Cam locks 320 preferably consist of two laterally projecting arms 301 which, when in the locked position, engage the underside of container rim 140. When container 100 is exposed to microwaves, the elasticity of the upper portion of side wall 120 of container 100 may increase. Thus, to ensure that arms 301 remain securely engaged to the underside of container rim 140, arms 301 are preferably of such length to firmly force the upper portion of side wall 120 against inner side wall 316 of lid 300.

An inwardly inclined, actuator lever arm 340 is connected to one end of the pivot pin 338 to rotate the pivot pin and to lock the cam lock. The lever arm 340 is angled to frictionally engage the lid outer sidewall 314 when the cam section 319 has been pivoted thereby into engagement with the underside of container rim 140. In a preferred embodiment, a clasp 342 is positioned at the end of lever arm 340 and is dimensioned to snap over peripheral rim 344 on the outer sidewall 314 of lid 300 in order to secure lid 300 onto container 100. Clasp 342 can, thus, be engaged to secure lid 300 to the container 100 by simply pushing actuator lever arm 340 to position A, as shown in FIG. 3 until clasp 342 snaps onto peripheral rim 344. To unlock the lid from the container, lever arm 340 is forced downwardly against the incline edge of outer sidewall to cause the pivot pin 338 to pivot the cam section 319 downwardly to a vertical position where lever arm 340 will be positioned at B in FIG. 3. Handle sidewalls 330 and 332 and lock mount sidewalls 334 and 336 each include a slot 339 through which pivot pin 338 can be removed when lever arm 340 is in position C. Slot 339 contains a circular shaped portion dimensioned to receive pivot pin 338 and a rectangular portion dimensioned to allow the passage of cam lock 320 therethrough, when pivot pin 338 and cam lock 320 are positioned 180° degrees relative to position A. The end of pivot pin 338, located distally from clasp 342 is slightly larger in diameter than slot 339, such that a slight degree of force is required to insert and remove pivot pin 338. This prevents the unintentional detachment from lid 300. Pivot pin 338 also includes a stop ring 317 of a diameter larger than slot 339 and which is positioned circumferentially around pivot pin 338. Stop pin 317 abuts against neck 324 to maintain cam section 319 in proper position.

By pushing downwards on lever arm 340, clasp 342 can be disengaged from peripheral rim 344. Thus, to lock and unlock lid 300 onto container 100, the lever arm 340 is simply pushed upwards and downwards, respectively. As illustrated in FIG. 4E, a top portion of clasp 342 includes an inwardly sloping face 341 having an angle of approximately 45° relative to outer side wall 312 when clamped onto outer rim 344. When lever arm 340 is pushed upwardly into the locked position, inwardly sloping face 341 of clasp 342 rubs against rim 344 forcing clasp 344 outward such that clasp 342 can be positioned over rim 344 without having to pull laterally on lever arm 340. Clasp 342 also includes an outwardly sloping face 343 having an angle of approximately 30° relative to outer side wall 312, that engages the upper portion of rim 344 when lever arm 340 is in the locked position. The bottommost edge 345 of clasp 342 extends under rim 344. The arrangement of inwardly sloping face 341, outwardly sloping face 343, and bottom edge 342 of clasp 342 creates a recess on the inside edge of clasp 342 for receiving rim 344 and creating an interference fit. The interference fit is small enough to prevent the inadvertent disengagement of clasp 342 from rim 344 under normal usage, but large enough permit disengagement to quickly relieve internal pressure if the internal pressure within container 100 becomes extraordinarily high.

The apparatus of the present invention allows for the quick, clean, and safe microwave cooking of bacon and other food items. Rack 200 is inserted into container, such that stem 230 is positioned at open end 130. Bacon is hung over vanes 210 of rack 200. The number of bacon strips accommodated by rack 200 primarily depends on the width of vanes 210 and the number of bacon strips loaded onto vanes 210. Obviously, when using wider bacon strip, a lesser number of strips fit on any one vane. Once the bacon is loaded onto rack 200, lid 300 is placed onto rack 200 by inserting stem 230 of rack 200 through central opening 319 such that tabs 250 on vane projections 240 are aligned with and inserted into slots 325 defined by the alignment tabs 323 extending from bore wall 321 until the underside of alignment tabs 323 engages support disc 260. Lid 200 is then rotated to align vane projections 240 with grooves 329. Then lid 200, with rack 200 attached, is placed into container 100. Once lid 100 is properly in place, lever arms 340 are pushed upwards such that clasps 342 securely snap onto peripheral rim 314 on the outside wall 312 of lid 300. With lid 300 securely fastened to container 100, bacon cooker 10 is then placed into a microwave oven and the bacon is cooked for a predetermined length of time.

Only by using a closed, covered cooking unit that contains grease splatter can bacon be effectively cooked in a microwave without having bacon grease soil the surfaces of the microwave. However, when bacon is microwaved in an enclosed cooker without a ventilating means, steam generated during cooking becomes so pressurized that the cooker can blow up, thereby spilling the hot contents of the cooker and potentially causing serious injury. All animal fats are composed of glyceryl esters of fatty acids, and as they cook, they release water in the form of steam via a process known as effervescence. As bacon cooks, the fat that drips from the bacon collects as liquid fat at the bottom on an enclosed cooker. The steam that effervesces from the bacon could build up pressure that could forcefully blow up an enclosed cooker. Even ventilation of steam through central opening 319 of lid 300, does not completely ensure that lid 300 will remain attached to container 100 during the cooking of bacon. Although most of the steam that effervesces from the bacon will be vented through central opening 319, some will condense on the cooler sides of container 100 as droplets which run down into the hot grease collected at the bottom of the container. The water that collects below the liquid bacon fat, is superheated due to the weight of the liquid bacon fat above it. The water gets even hotter as the layer of liquid fat gets thicker. The application of continued microwaves heats this water and converts it back to steam. When the steam rises upwards from the bottom of container 100 it tends to erupt through the surface of the liquid bacon fat, and if forceful enough, can blow lid 300 off container 100.

As long as water is present, the temperature of the liquefied fat cannot exceed the boiling point of water, which at sea level is 212° F. As the cooking continues, a point is reached when the water generated by the effervescence becomes insufficient to replenish the water lost through boiling from the bottom of container 100. Absent water, the temperature of the liquefied bacon fat can reach over 300° F., enough to melt the bottom portion of container 100. Unfortunately, the addition of a predetermined amount of water to the container to accommodate for the water loss from the container 200 collected as a result of effervescence results in the microwaves being attracted to the added water, rather than the bacon, thereby prolonging the cooking time and reducing the available crispiness of the bacon.

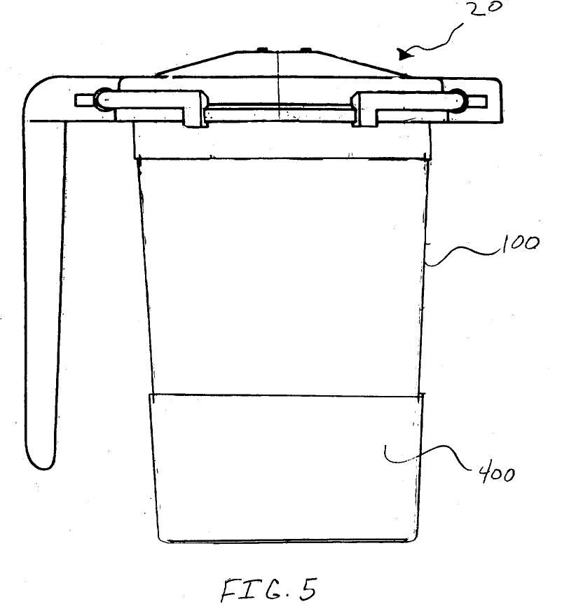

To overcome these problems, provided is, in another preferred embodiment, bacon cooker 20, as shown in FIG. 5. In addition to having the aforementioned components and features of bacon cooker 10 described above, and shown in FIGS. 1-4, a thin microwave reflective surface, such as aluminum foil, is positioned between cup 400 and container 100. The microwave reflective surface covers a major portion of container 100, but enough is left uncovered such that container 100 and cup 400 are in contact with one another. In an alternative embodiment, the microwave reflective surface can be electrostatically applied.

Container 100 is coated with a non-evaporative, viscous material capable of withstanding high temperatures, such as silicon grease, prior to applying the aluminum foil, so as to hold the aluminum foil in place when container 100 is inserted into cup 400 and to prevent the aluminum foil from tearing. Cup 400 is preferably bonded to container 100 by a vacuum seal which prevents cup 400 from disassociating and which effectively removes oxygen from between cup 400 and container 100 which could otherwise attribute to extensive arcing during microwaving. Alternatively, cup 400 can be bonded to container 100 by an adhesive. Cup 400 is preferably composed of unfilled high-melting temperature polypropylene, however any other microwave permeable materials with sufficiently high melting temperatures may also be employed.

When foil is used as the reflective surface positioned between cup 400 and container 100, it is important that the surface of the foil applied to container 100 remains smooth. If wrinkling or bunching of the foil occurs, air will, in time, leak into the space between cup 400 and container 100, causing cup 400 and container 100 to become detached from one another. Thus, in accordance with the method of the present invention, aluminum foil is placed over container 100 in a stepwise fashion prior to fastening cup 400 to container 100. In particular, in a preferred embodiment, a first strip of foil appropriate size relative to the size of container 100 is centered on the bottom of container 100 and each end is draped over the side of container 100. A second strip of foil of substantially equal size is centered on the bottom of container 100 and draped over the side of container 100 at a 90° angle to the first strip. A third strip of foil of substantially equal size is then centered on the bottom of container 100 and draped over the side of container 100 at a 45° angle relative to the second strip. Lastly, a fourth strip of foil of substantially equal size is then centered on the bottom of container 100 and draped over the side of container 100 at a 90° angle relative to the third strip, such that the container 100 is covered by the foil as herein described. Using this method, excessive wrinkling of the foil is eliminated and the maximum foil thickness on the side of container 100 is twice that of a single strip, thereby maintaining a uniform distribution of foil with insignificant interstices.

Microwaves are known to be deflected by metal, thus most containers are composed of microwavable non-metal plastics. In accordance with the present invention, the microwave reflecting surface effectively prevents microwaves from reaching the contents of container 100 where it is surrounded by the reflective surface. While microwave energy still reaches the contents of container 100 from above, it is at such a reduced level that the rate of evaporation permits the complete cooking of bacon while preventing to any possibility of explosion. Thus, the temperature of the water is maintained at a level such that the rate of evaporation does not exceed the rate of condensation formed from the effervescence. Accordingly, the liquefied bacon fat is maintained at a temperature lower than the melting point of container 100 for a long enough time that crisp bacon can be cooked without fear of generating explosive forces.

The embodiments of the invention shown and described herein are solely for exemplary purposes only and in no way limit the scope of the present invention.

What is claimed is:

1. A microwavable cooking apparatus for cooking bacon and the like, comprising:
a container, said container having at least one container sidewall, an inner and outer surface, an open end, and a laterally projecting rim at the open end defining a rim undersurface;
a lid, said lid including a body having a top wall dimensioned to extend across and close the open end of said container; and
a cooking rack consisting of a plurality of radially extending vanes, said rack being dimensioned to fit within said container.

2. The microwavable apparatus of claim 1, wherein the top wall of said lid includes at least one bore wall defining a centrally located bore extending perpendicularly through said lid.

3. The microwavable apparatus of claim 2, wherein said bore wall includes a plurality of laterally extending tabs positioned within said bore.

4. The microwavable cooking apparatus of claim 1, wherein a portion of the top wall of said lid is substantially dome-shaped.

5. The microwavable cooking apparatus of claim 1, wherein a handle is connected to said lid.

6. The microwavable apparatus of claim 5, wherein a first portion of said handle projects laterally from said lid and a second portion of the handle projects downward from the distal end of said first portion of said handle.

7. The microwavable apparatus of claim 1, wherein a plurality of container locks are mounted on said lid for movement between a locked position and an unlocked position, said container locks being positioned such that in the unlocked position a container may be positioned in engagement with the lid or removed from engagement with the lid, said container locks being positioned to move from an unlocked position into a locked position to engage the undersurface of said rim when the container is positioned in engagement with the lid.

8. The microwavable cooking apparatus of claim 7, wherein said container locks each include a cam section to engage and force said rim against the lid in the locked position of the container locks.

9. The microwavable cooking apparatus of claim 7, wherein said lid includes an outer sidewall extending outwardly from the periphery of said top wall, a lock mount for each container lock mounted on said outer wall and extending outwardly therefrom, a cam opening formed in said outer wall adjacent to said lock mount, each said container lock being mounted for pivotal movement on said lock mount and including a cam section which extends through the cam opening in said outer wall, said cam section operating to engage the undersurfaces of said rim against said body in the locked position of the container lock.

10. The microwavable cooking apparatus of claim 7, wherein each said container lock includes an operating lever connected to pivot said container lock between the locked and unlocked positions.

11. The microwavable cooking apparatus of claim 10, wherein said operating lever includes clasp dimensioned to securely engage the outer sidewall of said lid, when said container lock is in the locked position.

12. The microwavable cooking apparatus of claim 1, wherein the plurality of radially extending vanes are spaced substantially equidistant from one another.

13. The microwavable cooking apparatus of claim 12, wherein the plurality of vanes comprising said rack include an upwardly extending stem dimensioned to fit within said bore.

14. The microwavable cooking apparatus of claim 13, wherein said stem is comprised of a plurality of a radially extending vanes, said plurality of radially extending vanes being dimensioned to fit between said tabs and secure said lid to said container.

15. A microwavable cooking apparatus for cooking bacon and the like, comprising:
an outer container, said outer container having at least one container sidewall, an inner and outer surface, an open end and a laterally projecting rim at the container open end defining a rim undersurface;
an inner container, said inner container having at least one container sidewall, an inner and outer surface, and an open end and dimensioned to fit within said outer container;
a lid, said lid including a body having a top wall dimensioned to extend across and close the open end of said container; and
a cooking rack consisting of a plurality of radially extending vanes, said rack being dimensioned to fit within said inner container.

16. The microwavable cooking apparatus of claim 15, wherein said outer container covers a predefined portion of said inner container, and wherein a microwave reflecting surface is positioned between said outer container and said inner container.

17. The microwavable cooking apparatus of claim 16, wherein a vacuum seal is formed between said outer container and said inner container.

18. The microwavable apparatus of claim 15, wherein the top wall of said lid includes at least one bore wall defining a centrally located bore extending perpendicularly through said lid.

19. The microwavable apparatus of claim 18, wherein said bore wall includes a plurality of laterally extending tabs positioned within said bore.

20. The microwavable cooking apparatus of claim 15, wherein a portion of the top wall of said lid is substantially dome-shaped.

21. The microwavable cooking apparatus of claim 15, wherein a handle is connected to said lid.

22. The microwavable apparatus of claim 21, wherein a first portion of said handle projects laterally from said lid and a second portion of the handle projects downward from the distal end of said first portion of said handle.

23. The microwavable apparatus of claim 15, wherein a plurality of container locks are mounted on said lid for movement between a locked position and an unlocked position, said container locks being positioned such that in the unlocked position a container may be positioned in engagement with the lid or removed from engagement with the lid, said container locks being positioned to move from an unlocked position into a locked position to engage the undersurface of said rim when the container is positioned in engagement with the lid.

24. The microwavable cooking apparatus of claim 15, wherein said container locks each include a cam section to engage and force said rim against the lid in the locked position of the container locks.

25. The microwavable cooking apparatus of claim 15, wherein said lid includes an outer sidewall extending outwardly from the periphery of said top wall, a lock mount for each container lock mounted on said outer wall and extending outwardly therefrom, a cam opening formed in said outer wall adjacent to said lock mount, each said container lock being mounted for pivotal movement on said lock mount and including a cam section which extends through the cam opening in said outer sidewall, said cam section operating to engage the undersurfaces of said rim against said body in the locked position of the container lock.

26. The microwavable cooking apparatus of claim 23, wherein each said container lock includes an operating lever connected to pivot said container lock between the locked and unlocked positions.

27. The microwavable cooking apparatus of claim 26, wherein said operating lever includes clasp dimensioned to securely engage the outer sidewall of said lid when said container lock is in the locked position.

28. The microwavable cooking apparatus of claim 15, wherein the plurality of radially extending vanes are spaced substantially equidistant from one another.

29. The microwavable cooking apparatus of claim 15, wherein the plurality of vanes comprising said rack include an upwardly extending stem dimensioned to fit within said bore.

30. The microwavable cooking apparatus of claim 29, wherein said stem is comprised of a plurality of a radially extending vanes, said plurality of radially extending vanes being dimensioned to fit between said tabs and secure said lid to said container.

31. A method for microwave cooking bacon and the like, comprising the steps of:
suspending strips of bacon in spaced relationship to the bottom wall of an enclosed microwave permeable container; and
subjecting the container and bacon strip to microwave energy.

32. The method of claim 31, wherein said container includes a microwave reflecting surface embedded within the sides of said container.
